(19) United States
(12) Patent Application Publication
(10) Pub. No.: US 2015/0263861 A1
(43) Pub. Date: Sep. 17, 2015

(54) VERIFYING THE AUTHENTICITY OF A LIGHTING DEVICE

(71) Applicant: KONINKLIJKE PHILIPS N.V., Eindhoven (NL)

(72) Inventors: Sandeep Shankaran Kumar, Waalre (NL); Oscar Garcia Morchon, Aachen (DE); Sye Loong Keoh, Eindhoven (NL); Theodorusb Jacobus Johannes Denteneer, Eindhoven (NL); Lorenzo Feri, Eindhoven (NL)

(21) Appl. No.: 14/433,071

(22) PCT Filed: Sep. 12, 2013
(86) PCT No.: PCT/IB2013/058476

§ 371 Date: Apr. 2, 2015

Related U.S. Application Data
(60) Provisional application No. 61/710,135, filed on Oct. 5, 2012.

(51) Int. Cl. H04L 9/32; H05B 37/02; H04B 10/116

(52) U.S. Cl. CPC H04L 9/3271; H04B 10/116; H05B 37/0272

(57) ABSTRACT

The present invention relates to verification of the authenticity of a lighting device. There is provided a lighting device which is capable of emitting coded light. The lighting device has a challenge receiver, arranged to receive a challenge, and a response transmitter, arranged to generate and transmit a response to the challenge. The response is generated by means of the challenge and a secret key in combination. Furthermore, there is provided a corresponding verification device generating the challenge and providing it to the lighting device, and analyzing the response in order to check the authenticity of the lighting device.

### FIELD OF THE INVENTION

The present invention relates to verification of the authenticity of a lighting device.

### BACKGROUND OF THE INVENTION

Providing a lighting device with the capability of transmitting information by means of coding its light output is a recent communication technology. The light communication is typically confined to an area or a room. This new technology is attractive, but guarded by patent rights. It would be an advantage to be able to remotely verify that a lighting device is an original product manufactured by a licensed manufacturer and not a counterfeit. There is no such prior art lighting device or verification device.

### SUMMARY OF THE INVENTION

It is an object of the present invention to provide a lighting device, a verification device, and a method of verifying the authenticity of a lighting device.

The object is achieved by a lighting device according to the present invention as defined in claim 1, a verification device as defined in claim 7, and a method of verifying the authenticity of a lighting device as defined in claim 11.

The basic idea of the invention is to provide a simple and reliable way of checking in the field if a lighting device is validly manufactured by the original manufacturer or a licensee or if it is a counterfeit product.

Thus, in accordance with an aspect of the present invention, there is provided a lighting device arranged to transmit information by coding its output light, comprising:
at least one light emitter;
a light coding unit, arranged to code the light emitted by said at least one light emitter;
a challenge receiver arranged to receive a challenge via a first communication channel; and
a response transmitter arranged to generate and transmit a response to the challenge via a second communication channel by means of said light coding unit, wherein the response is based on a combination of a secret key, provided in advance in the lighting device, and the challenge.

The second communication channel may be different from the first communication channel.

The lighting device is advantageously provided with a capability of handling a challenge and providing a response to that challenge, which is based on a combination of the challenge as such and a secret key. The nature of a challenge, as is per se known and described in literature about secure communication, is that it is a temporary or arbitrarily changing parameter, which prevents a replay attack. Thus, by basing the response on both a secret key and a challenge the likelyhood of determining a non-authentic lighting device as authentic is very low.

Additionally, by using the light coding functionality that the lighting device already has for communicating the response, and a different communication channel for providing the lighting device with the challenge, the latter can be made very simple, as will be evident from different embodiments to be described below.

In accordance with an embodiment of the lighting device, the response transmitter is arranged to encrypt the challenge with the secret key, and the response comprises the challenge encrypted with the secret key. To use the key to encrypt the challenge is one advantageous way to provide the lighting device with the ability to generate a secure response.

In accordance with an embodiment of the lighting device, the response transmitter is arranged to generate an authentication code, and the response comprises the authentication code. This is another advantageous way to provide the lighting device with the ability to generate a secure response.

In accordance with an embodiment of the lighting device, the first communication channel comprises a switch, which is arranged to be operated for providing the challenge to the lighting device. Thereby there is no need for any separate sensor at the lighting device for receiving the challenge.

In accordance with an embodiment of the lighting device, the first communication channel comprises a sensor. Thereby it is possible to receive the challenge by wireless transmission, such as audible transmission, visible light transmission, infrared light transmission, radio transmission, etc.

In accordance with an embodiment of the lighting device, the response further comprises a key identifier.

In accordance with another aspect of the present invention, there is provided a verification device arranged to verify the authenticity of a lighting device, which is arranged to transmit information by coding its output light, comprising:
a challenge generator arranged to generate a challenge for the lighting device;
a challenge transmitter arranged to transmit the challenge to the lighting device via a first communication channel;
a response receiver arranged to receive a response to the challenge from the lighting device via a different second communication channel using light coding; and
an authenticity verifier arranged to determine the authenticity of the lighting device by comparing the response with a reference, wherein the response is based on a combination of a secret key, provided in advance in the verification device, and the challenge.

The verification device is advantageously provided with a capability of generating a challenge and handling a response to that challenge, which is based on at least the challenge as such and a secret key. Thereby, as mentioned in conjunction with the lighting device above, replay attacks are prevented.

In accordance with an embodiment of the verification device, the challenge transmitter comprises a signal actuator arranged to transmit a signal. Thereby it is comfortable to provide the lighting device with the challenge.

In accordance with an embodiment of the verification device, the challenge transmitter comprises an operator interface, and is arranged to provide an operator with instructions for controlling a power switch of the lighting device. On the other hand, this embodiment eases the demands of particular elements at the lighting device for receiving signals.

In accordance with a further aspect of the present invention, there is provided a method of verifying the authenticity of a lighting device, which is able to transmit information by coding its light output, comprising:
generating a challenge with a verification device;
providing the challenge to a lighting device via a first communication channel;
receiving a response to the challenge at the verification device via a second communication channel involving said coding of the light output of the lighting device; and
verifying the authenticity of the lighting device by comparing the response with a reference, wherein the response is based on a combination of a secret key, provided in advance in both the lighting device and the verification device, and the challenge.

The method provides corresponding advantages as the lighting device and the verification device.

In accordance with an embodiment of the method, the operation of providing a challenge to a lighting device comprises prompting a user to input an on-off sequence of a particular duration to the lighting device. The method further comprises measuring the duration at the lighting device; transmitting the measured duration to the verification device; and checking, at the verification device, that the measured duration corresponds, within a predefined margin, to the particular duration.

An advantage of this embodiment is that there is no need for providing the lighting device with equipment for receiving signals sent directly from the verification device.

These and other aspects, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIGS. 1-3 are schematic general views of embodiments of verification systems according to the present invention;

FIGS. 4-6 are block diagrams of embodiments of lighting devices and verification devices according to the present invention; and

FIG. 7 is a flow chart of an embodiment of a method of verifying the authenticity of the lighting device.

### DESCRIPTION OF PREFERRED EMBODIMENTS

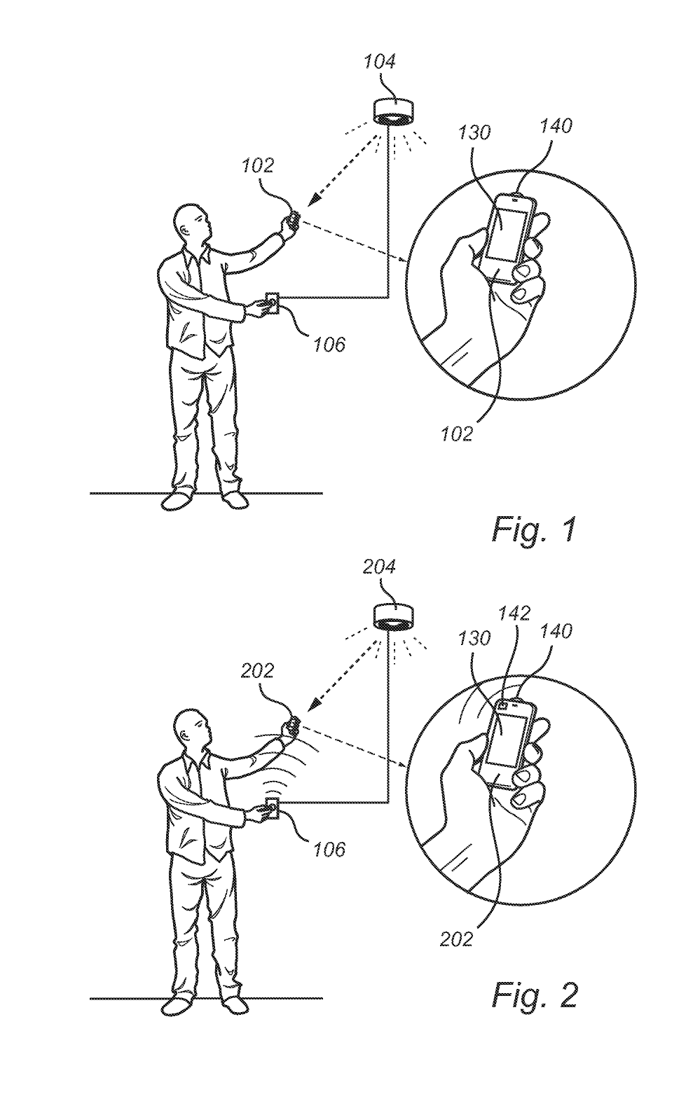

In order to provide an intuitive understanding of the present invention, embodiments of a verification system including a verification device and one or more lighting devices will be briefly explained in conjunction with FIGS. 1 to 3. Additionally, a more detailed description will follow with reference to the other figures. Thus, according to a first embodiment of the verification system 100, it comprises a first embodiment of the verification device 102, and a first embodiment of at least one lighting device 104, which is arranged to transmit information by coding its output light. Typically, the coding is performed by controlling the drive signals to the light emitters of the lighting device 104 such that a pulse sequence embodying the information is emitted. One common technique is to use a lighting device, which is equipped with PWM (Pulse Width Modulation) controllable light emitters, but there exist other techniques as well. The pulse frequency of the pulse sequence is high enough to make it invisible to the human eye. There are many prior art examples of light coding, and therefore it will not be described in greater detail here. For sake of simplicity this description describes the case of a single lighting device, while it is understood that it works similarly for checking the authenticity of several lighting devices, one at a time. The power supply to the lighting device 104 is controlled by a power switch 106, which is also involved in the authenticity check in this embodiment.

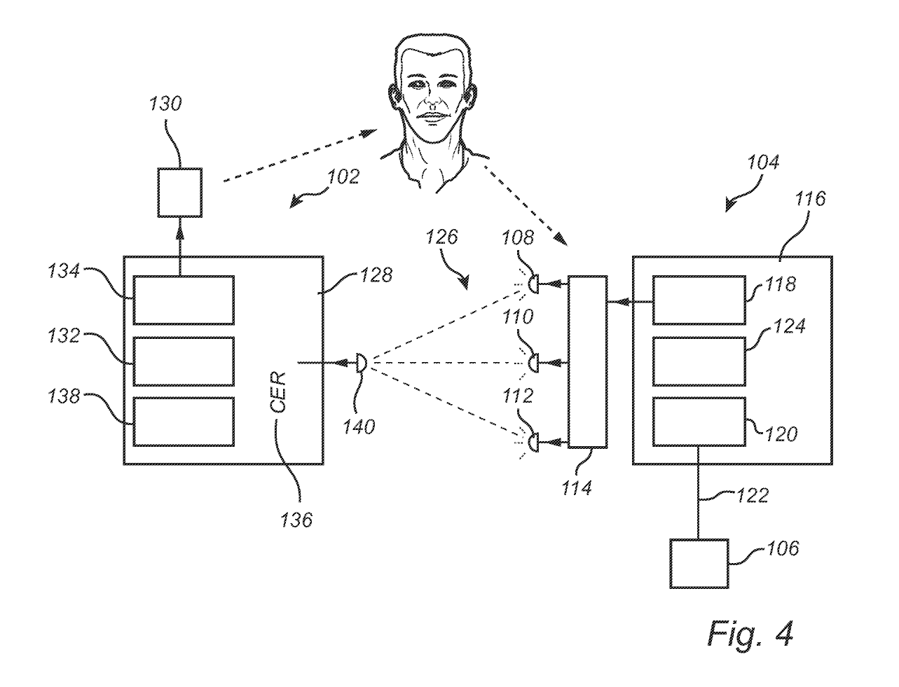

Referring to the most schematic block diagram of FIG. 4, the lighting device 104 comprises red, green and blue light LED (Light Emitting Diode) emitters 108, 110, 112, which can be less than three and more than three, and other colors including white, as well. In addition to LEDs the light emitters can be of any kind, which is controllable to emit coded light. Further, the lighting device 104 comprises a driver 114, which is connected to the light emitters 108, 110, 112, and a control unit 116, which controls the light output of the lighting device 104, and which is connected to the driver 114. The control unit 116 comprises a light coding unit 118, which is connected to the driver 114, and which is arranged to code the light emitted by the light emitters 108, 110, 112. Furthermore, the control unit 116 comprises a challenge receiver 120, which is arranged to receive a challenge via a first communication channel 122, and a response transmitter 124, which is arranged to generate and transmit a response to the challenge via a second communication channel 126 by means of the coding unit 118.

The verification device 102 is arranged to verify the authenticity of the lighting device, and comprises a control unit 128, and an operator interface 130. The control unit comprises a challenge generator 132, which is arranged to generate a challenge for the lighting device 104, and a challenge transmitter 134, which is arranged to transmit the challenge to the lighting device 104 via the first communication channel 122. Furthermore, the control unit 128 of the verification device 102 comprises a response receiver, 136, which is arranged to receive the response from the lighting device 104 via the second communication channel 126, and an authenticity verifier 138, which is arranged to determine the authenticity of the lighting device 104. The response receiver 136 comprises a light sensor 140, which is arranged to sense the coded light emitted by the lighting device 104.

The authenticity procedure involves generating a response, which is based on at least a secret key K, which is provided in advance at both the verification device 102, and the lighting device 104, and the challenge n. Then, the response R can be expressed by:

R=F(K, n) eqn. 1

where F represents a response function having the key K and the challenge n as parameters. The function can be any type of appropriate cryptographic function, such as a, a Message Authentication Code (MAC), or an encryption function where the challenge n is encrypted with the secret key K.

The secret key K can be unique to each lighting device, to each manufacturer, to a rights owner, etc. At least in the cases where there are several different secret keys, the secret key K is bound to an identifier ID_{K}, which is known to both the verification device 102 and the lighting device 104. Thus, the verification device 102 is provided with a single secret key K, a single secret key and a single identifier ID_{K}, or several identifiers ID_{K} depending on which case is at hand. When an identifier ID_{K} is present at the lighting device 104, the response comprises the identifier ID_{K} as well:

R={ID_{K}, F(K, n)} eqn. 2

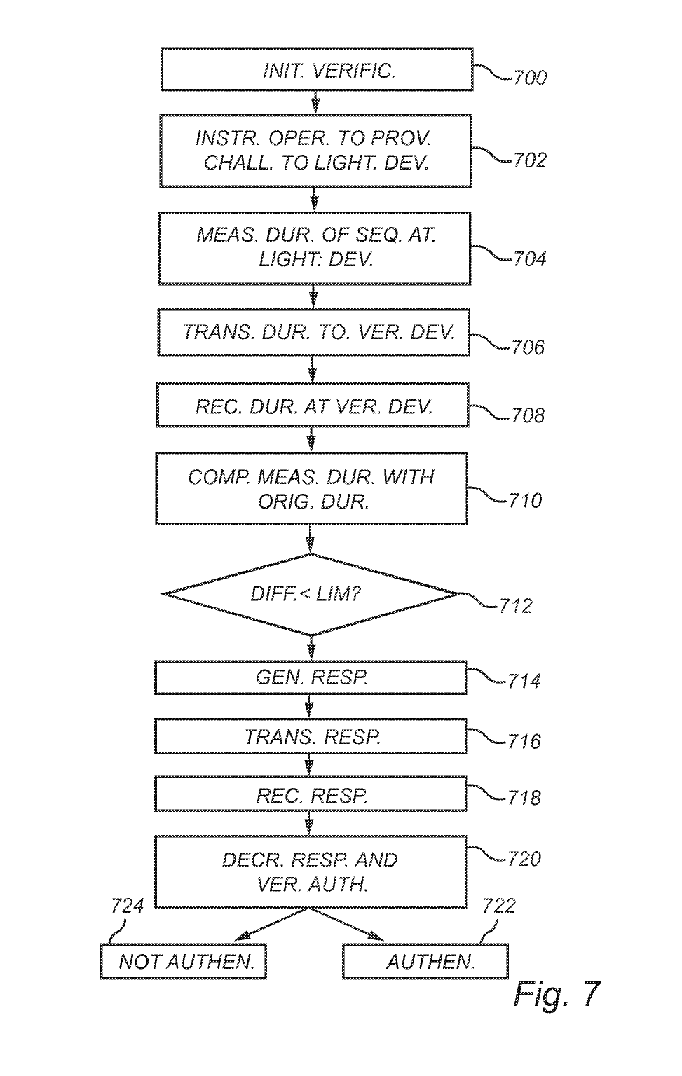

The overall operation is that a challenge n is generated by means of the verification device 102, and provided to the lighting device 104 via the first communication channel 122, which returns a response R via the second communication channel 126, which involves the coded light transmission. More particularly, in this embodiment, the operation of providing the lighting device 104 with the challenge includes that initially the operator initiates the verification by entering a predetermined on/off sequence with the power switch 106, see box 700 of FIG. 7. Thereby the lighting device 104 knows that it is going to receive a challenge from the verification device 102. Then the challenge n is generated by the verification device 102 as a duration of a sequence of on/off switches. The length of the duration is randomly determined, and therefore it is not known beforehand by the lighting device 104. Thereby the security is high as explained above. The operation of providing the challenge n to the lighting device 104 further comprises that the sequence and duration are shown on a display of the operator interface 130, and the operator is instructed to provide the challenge to the lighting device 104, see box 702, and that the operator inputs the sequence to the lighting device 104 by means of the switch 106. The duration is measured by the lighting device 104, box 704, and is then transmitted to the verification device 102 by means of a coded-light sequence, box 706. The coded-light sequence is received by the response receiver 136, via its light sensor 140, of the verification device 102, box 708. The received light signal is decoded by the response receiver 136 and the measured duration thus received from the lighting device 104 is compared with the originally generated duration, box 710. This is done to prevent a replay attack. If the difference is small enough, i.e. below a predetermined limit it is determined that it is a newly determined value, and not part of a replay, or randomly generated by an attacker. If the duration can be predicted, or is static or known to an attacker, then there is a risk that the response can be replayed.

Next step is that the lighting device 104 uses the duration as a challenge and generates a response to the challenge by means of above-described equation 1 or 2 depending on whether an identification is used or not, box 714. Then the lighting device 104 transmits the response R to the verification device 102 by means of coding the light output, box 716. The response R is received and light decoded by the response receiver 136, box 718, and fed to the authenticity verifier 138. The authenticity verifier 138 compares the received response with a reference to check that the lighting device has used the correct secret key. More particularly, in case of an encryption function, it decrypts the response by means of the secret key K, and checks the embedded challenge, box 720, and in case of a MAC the verification device 102 uses the received measured duration and the secret key to generate a MAC and checks that it corresponds with the MAC received from the lighting device 104. If affirmative, and if the above-mentioned difference was small enough, the lighting device 104 is determined to be authentic, box 722, otherwise it is determined to be non-authentic, box 724. This final result is shown on the display 130.

As regards the duration it can be handled in alternative ways. For instance the comparison between the originally generated duration and the measurement of the duration performed by the lighting device 104, can be done at the end after having decrypted the received response. Depending on the cryptographic function, it may not be possible to recover the secret key if the challenge, i.e. the duration, has been wrongly measured, and no separate comparison of durations is needed. Yet another alternative is that the comparison is made as described with reference to FIG. 7, and if the difference is too large, the verification device 102 simply disregards the response from the lighting device and directly provide a non-authentic message to the operator interface 130.

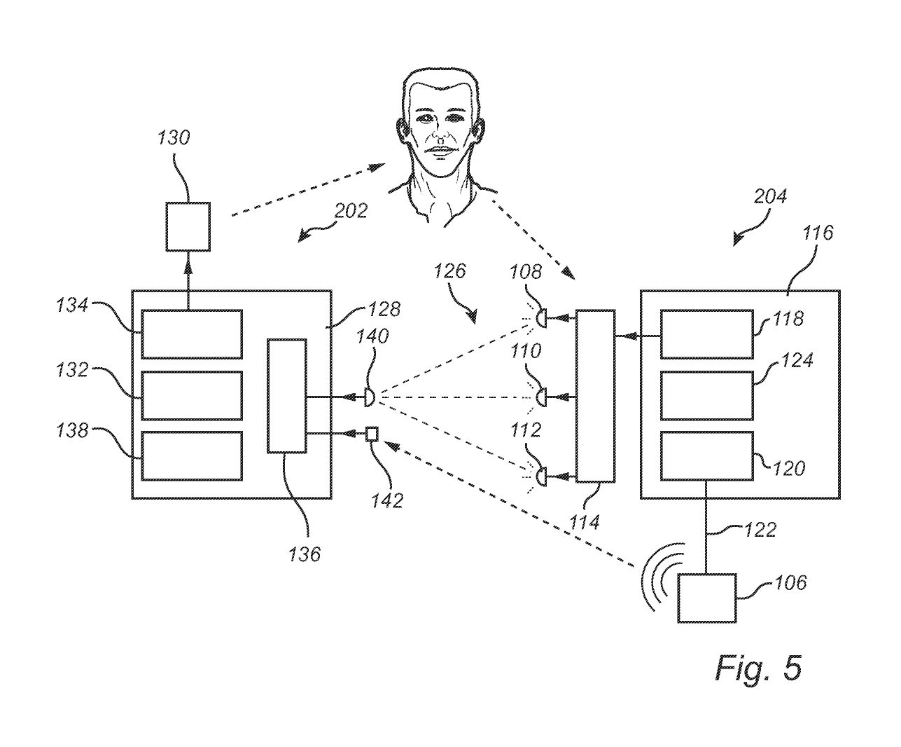

In accordance with a second embodiment of the verification device 202, schematically illustrated in FIG. 5, it comprises the same parts as the first embodiment, which are shown with the same reference numerals as in FIG. 4, except for one additional part, which is a microphone 142. A second embodiment of the lighting device 204 comprises the same parts as in the first embodiment, and they are provided with the same reference numerals.

The operation of the second embodiments of the verification device 202 and the lighting device 204 is as follows. In comparison with the first embodiments all actions are the same except for those pertaining to the acknowledgement of the challenge. Thus, the verification procedure is initiated with an on/off sequence input to the lighting device 204 by the operator switching the switch 106, just like in the first embodiment. Then the challenge is generated by the verification device 202, and input as an on/off sequence to the lighting device by the operator by means of the switch 106, like in the first embodiment. Then the lighting device 204 measures the duration of the sequence. However, instead of transmitting the measured duration from the lighting device 204 to the verification device 202, the verification device 202 as well measures the duration. This measurement is done by means of the microphone 142 registering the click sounds of the switch 106, when being switched on and off The duration thus measured by both the lighting device 204 and the verification device 202 is taken as the actual challenge to use in the continued verification process. Consequently, in this second embodiment of the method, there is no need for the verification device to check the correctness of the measurement performed by the lighting device 204, but the verification process continues with the lighting device 204 generating the response R, etc., like in the first embodiment.

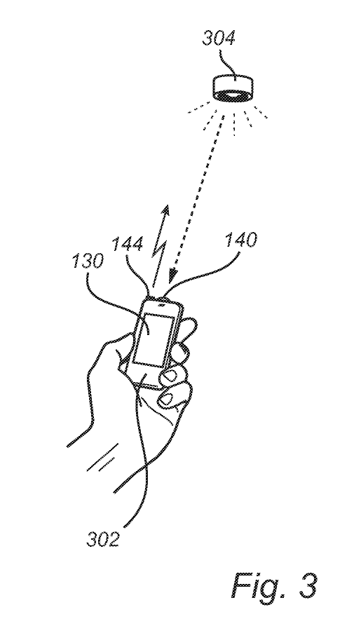

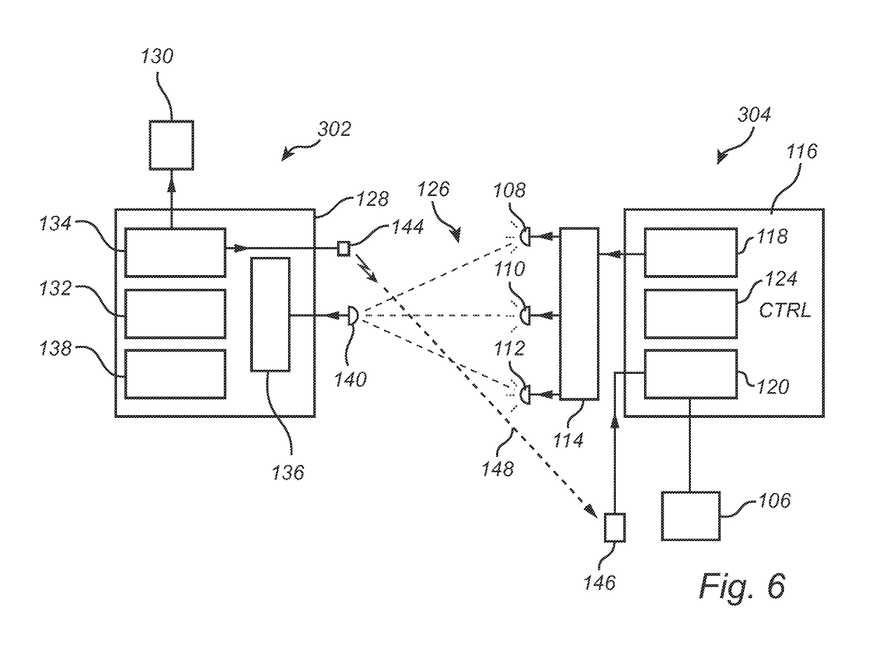

According to a third embodiment of the verification system, and of the verification device 302, and the lighting device 304, as illustrated in FIGS. 3 and 6, the verification device 302 comprises the same parts as the first embodiment plus a challenge actuator 144. The lighting device 304 comprises the same parts as the first embodiment plus a challenge sensor 146. The challenge actuator 144 is comprised in the challenge transmitter 134; the challenge sensor 146 is comprised in the challenge receiver 120; and the first communication channel 148 is established between them. The challenge actuator 144 is arranged to transmit the challenge wirelessly to the lighting device 304, by means of e.g. ultra-sound, infrared light, visible light, radio transmission, or any other suitable type of wireless communication. Typically, the already present sensor in the lighting device is used. For instance, the lighting device is typically equipped with a daylight sensor, or an ultra-sonic sensor.

Consequently, a third embodiment of the method of verifying the authenticity of the lighting device 304 is carried out as follows. The challenge transmitter 134 transmits a start verification command to the lighting device 304 via the first communication channel 148. The start communication command is received by the challenge receiver of the lighting device 304 via the challenge sensor 146 and as a result the lighting device 304 is set in a verification mode awaiting the challenge. Next, the verification device 302 generates the challenge by means of the challenge generator 132 and transmits the challenge to the lighting device by means of the challenge transmitter 134, via the challenge actuator 144. The rest of the verification procedure is similar to that of the second embodiment, and will not be repeated.

Above embodiments of the lighting device, the verification device, and the method of verifying the authentication of the lighting device according to the present invention as defined in the appended claims have been described. These should only be seen as merely non-limiting examples. As understood by the person skilled in the art, many modifications and alternative embodiments are possible within the scope of the invention as defined by the appended claims.

It is to be noted that for the purposes of his application, and in particular with regard to the appended claims, the word “comprising” does not exclude other elements or steps, and the word “a” or “an” does not exclude a plurality, which per se will be evident to a person skilled in the art.

1. A lighting device comprising:
at least one light emitter;
a receiver arranged to receive a challenge via a first communication channel; and
a response transmitter arranged to generate a response to the challenge, and to transmit the response via a second communication channel by coding the light emitted by said at least one light emitter, wherein the response is based on at least a secret key, provided in advance in the lighting device, and the challenge.

2. The lighting device according to claim 1, wherein the response transmitter is arranged to encrypt the challenge with the secret key, and wherein the response comprises the challenge encrypted with the secret key.

3. The lighting device according to claim 1, wherein the response transmitter is arranged to generate an authentication code, wherein the response comprises the authentication code.

4. The lighting device according to claim 1, wherein the first communication channel comprises a switch, which is arranged to be operated for providing the challenge to the lighting device.

5. The lighting device according to claim 1, wherein the first communication channel comprises a sensor.

6. The lighting device according to claim 1, wherein the response further comprises a key identifier.

7. A verification device arranged to verify the authenticity of a lighting device, which is arranged to transmit information by coding its output light, comprising:
a challenge generator arranged to generate a challenge for the lighting device;
a challenge transmitter arranged to transmit the challenge to the lighting device via a first communication channel;
a response receiver arranged to receive a response to the challenge from the lighting device via a second communication channel using light coding; and
an authenticity verifier arranged to determine the authenticity of the lighting device by comparing the response with a reference, wherein the response is based on at least a secret key, provided in advance in the verification device, and the challenge.

8. The verification device according to claim 7, wherein the challenge transmitter comprises a signal actuator arranged to transmit a signal.

9. The verification device according to claim 7, wherein the challenge transmitter comprises an operator interface, and is arranged to provide an operator with instructions for controlling a power switch of the lighting device.

10. A verification system for verifying the authenticity of a lighting device, the system comprising a lighting device according to claim 1.

11. A method of verifying the authenticity of a lighting device, which is able to transmit information by coding its light output, comprising:
generating a challenge with a verification device;
providing the challenge to a lighting device via a first communication channel;
receiving a response to the challenge at the verification device via a second communication channel involving said coding of the light output of the lighting device; and
verifying the authenticity of the lighting device by comparing the response with a reference, wherein the response is based on a combination of a secret key, provided in advance in both the lighting device and the verification device, and the challenge.

12. The method according to claim 11, said providing a challenge to a lighting device comprising transmitting the challenge wirelessly to the lighting device.

13. The method according to claim 11, said providing a challenge to a lighting device comprising prompting a user to input an on-off sequence of a particular duration to the lighting device; the method further comprising measuring the duration at the lighting device; transmitting the measured duration to the verification device; and checking, at the verification device, that the measured duration corresponds, within a predefined margin, to the particular duration.

14. The lighting device according to claim 1, wherein the first communication channel involves the power supply to the lighting device.

15. The verification device according to claim 7, comprising a sound sensor arranged to sense click sounds from a power switch of a lighting device.
